(19) United States
(12) Patent Application Publication
(10) Pub. No.: US 2016/0267201 A1
(43) Pub. Date: Sep. 15, 2016

(54) METHOD FOR CONSTRUCTION OF A STEP FEATURE IN A 3D MODEL

(71) Applicant: SIEMENS PRODUCT LIFECYCLE MANAGEMENT SOFTWARE INC., Plano, TX (US)

(72) Inventors: Eric Mawby, Northfield, MN (US); Derek England, Corona, CA (US); Dong Ping (Tony) Zhang, Shanghai Pudong New Area (CN); Xiaoqing Zhao, Putuo (CN)

(21) Appl. No.: 14/435,425

(22) PCT Filed: May 13, 2014
(86) PCT No.: PCT/CN2014/077374

§ 371 Date: Apr. 13, 2015

(51) Int. Cl. G06F 17/50; G06F 3/0484; G06T 19/20

(52) U.S. Cl. CPC G06F 17/50; G06T 19/20; G06F 3/04847; G06F 3/04845; G06F 3/04842; G06T 2210/21

(57) ABSTRACT

Methods for CAD modeling and corresponding systems (100) and computer-readable mediums (126). A method includes receiving (505) a solid model (200) including a plurality of parts and receiving (510) a selection of a first part (210) and a second part (220) of the solid model. The method includes identifying (515) an interference (230) between the first part and the second part and determining (520) a step feature modification (240) to the first part based on the identified interference. The method includes modifying (525) the first part to add the step feature modification to create a modified solid model (250) and storing (530) the modified solid model.

### TECHNICAL FIELD

The present disclosure is directed, in general, to computer-aided design, visualization, and manufacturing systems (“CAD” systems), product lifecycle management (“PLM”) systems, and similar systems, that manage data for products and other items (collectively, “Product Data Management” systems or PDM systems).

### BACKGROUND OF THE DISCLOSURE

CAD systems are useful for designing and modeling parts and products. Improved systems are desirable.

### SUMMARY OF THE DISCLOSURE

Various disclosed embodiments include methods for CAD modeling and corresponding systems and computer-readable mediums. A method includes receiving a solid model including a plurality of parts; and receiving a selection of a first part and a second part of the solid model. The method includes identifying an interference between the first part and the second part and determining a step feature modification to the first part based on the identified interference. The method includes modifying the first part to add the step feature modification to create a modified solid model and storing the modified solid model.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIGS. 2A and 2B illustrate an example of interfering parts in an assembly and a step feature that can be added using techniques disclosed herein;

FIG. 3 illustrates several faces of a CAD model, in several orientations, in accordance with disclosed embodiments;

FIGS. 4A-4C illustrate models with various step features to accommodate respective second parts, in accordance with disclosed embodiments; and

FIG. 5 illustrates a flowchart of a process in accordance with disclosed embodiments.

### DETAILED DESCRIPTION

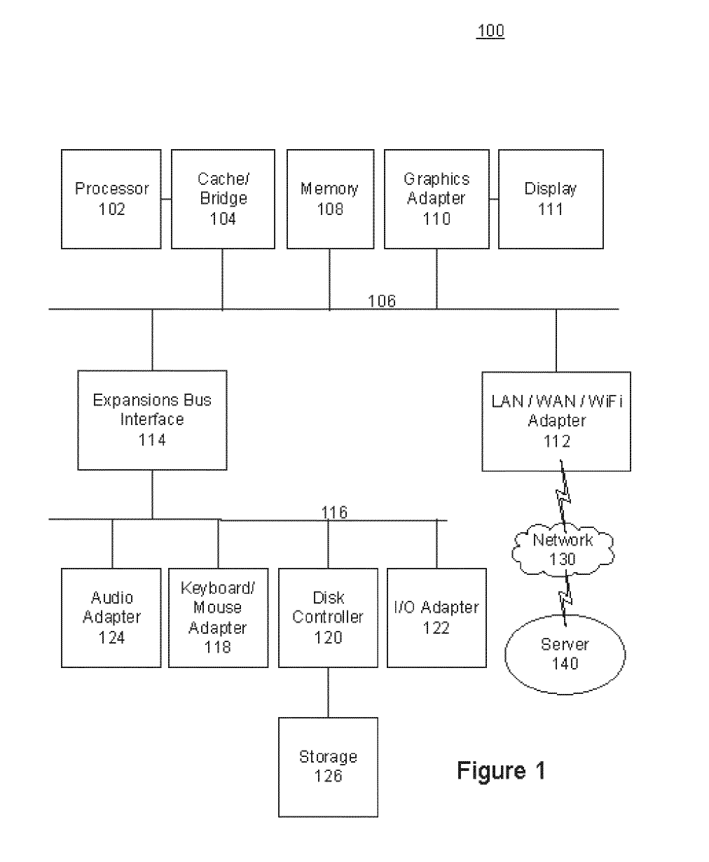

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In aerospace design and other fields, parts, products, structures, and other assemblies are often designed using CAD systems. In many cases, individual parts of an overall assembly may be separately designed and modeled before being assembled in the CAD system. When two parts of a structure or assembly are intended to abut or interact with each other, one or another of the parts may need to be modified to allow the parts to properly interact. For example, a “step” feature may need to be added to one of the parts to accommodate the shape of the other part. Disclosed embodiments include systems and method for step features in solid models.

FIG. 1 illustrates a block diagram of a data processing system in which an embodiment can be implemented, for example as a CAD system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments can modify a volumetric region of a 3D model to introduce a “step” (sometimes also referred to as a jog, lap, or cut) where the volume of a target part would otherwise interfere with the volume of a neighbor part in an assembly of parts. The modification produces a face in the target part to coincide with a face of the neighbor part such that the two parts may assemble in 3D space without interfering.

Techniques disclosed herein address an issue that can arise commonly when modeling inter-connected airframe parts, for example. While specific examples herein may address characteristics of airframe parts, the disclosed techniques are applicable to any modeled assembly of solid or wireframe parts.

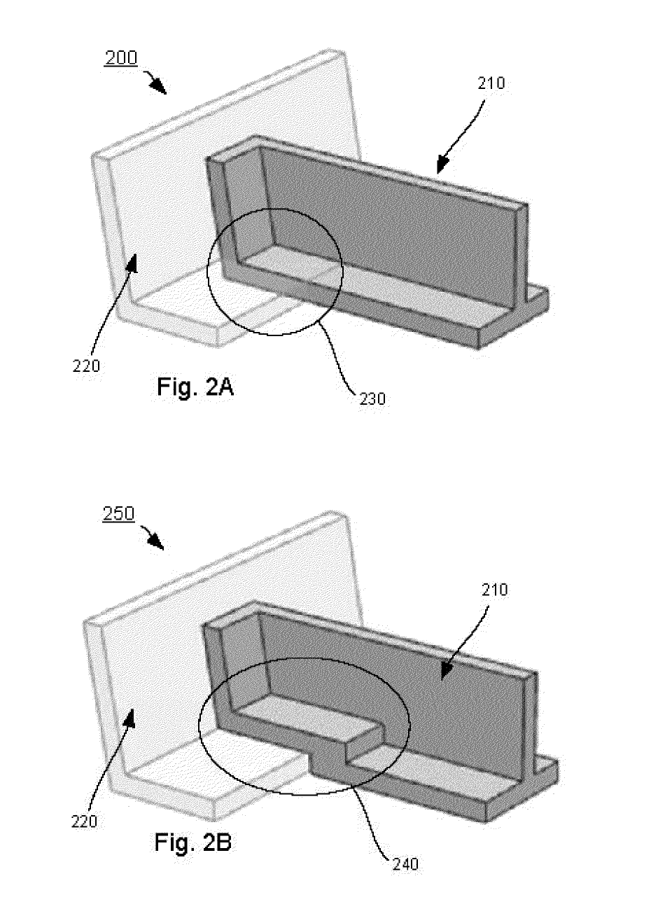

FIGS. 2A and 2B illustrate an example of interfering parts in an assembly and a step feature that can be added using techniques disclosed herein.

FIG. 2A illustrates a CAD solid model 200 that includes a plurality of parts, in this example a first part 210 and a second part 220, each placed where they are intended to be placed in the assembly. In this example, the first part 210 and second part 220 are intended to conform to each other so that they can be placed together, but the original shapes of first part 210 and second part 220 cannot be placed together as intended since they collide and interfere with each other, as generally indicated by the area 230.

FIG. 2B illustrates modified CAD solid model 250 after a step feature 240 has been added according to disclosed methods. As can be seen, first part 210 is modified by adding the step feature 240 so that it can remain in its proper position but now conforms to second part 220 without interfering.

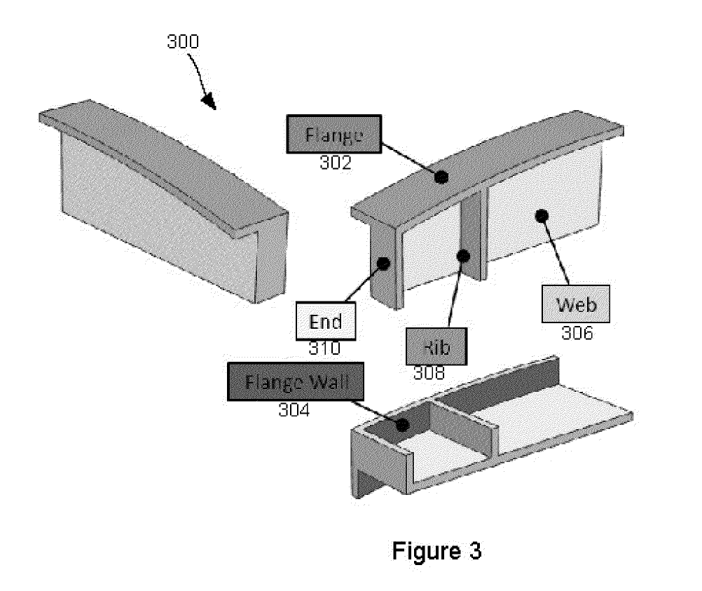

Disclosed embodiments can accommodate unique volumetric and topological characteristics of a part such as an airframe part or others. FIG. 3 illustrates several faces of a CAD model 300, in several orientations, in order to illustrate terms that may be used in the description here. These terms are used for illustration and may not be the same terms that every CAD user would use to describe similar features of CAD models. While some specific terms used below are described in the context of an airframe model, similar terms are commonly used for similar solid model features.

A flange refers to a projecting collar or rim on an object for locating or strengthening it or for attaching it to another object, as illustrated by flange face 302. In an airframe, the flange typically contacts the skin of the aircraft. The flange is often a thin-wall volume. The flange can be modified as described herein.

A flange-wall face 304 is a counterpart of the flange face, offset from the flange face to form the characteristic thin wall of the flange. Note that the flange-wall faces on one side of the web do not necessarily correspond exactly with faces on the opposite side of the web.

A web 306 is a thin-wall volume that intersects the flange. The web of an airframe part typically contains multiple hundreds of features, mostly ribs, shallow pockets, cutouts, and holes.

A rib 308 is a thin-wall volume that intersects the web and the flange. Not every rib in an airframe part intersects the flange but a rib that is potentially pertinent to the step feature processes described herein does intersect the flange.

The “end” 310 or end wall is effectively a rib but topologically different from the rib 308 illustrated. The outer face of the end wall intersects the flange face; the inner face of the end wall intersects the flange-wall face. Not every flange has an end wall. Note the opposite end of the flange 302 in this illustration does not have an end wall.

Using the processes described herein, the topology of any or all of these faces may be modified.

In various embodiments, the processes described herein can be performed based on different user inputs. For example, these processes can receive, as a user input, a selection of a first part and a second as input, which can include specific faces, such as a flange face on the first part. User inputs can include several parameters such as length and depth. The length of the added step feature may encounter and accommodate variations in topology.

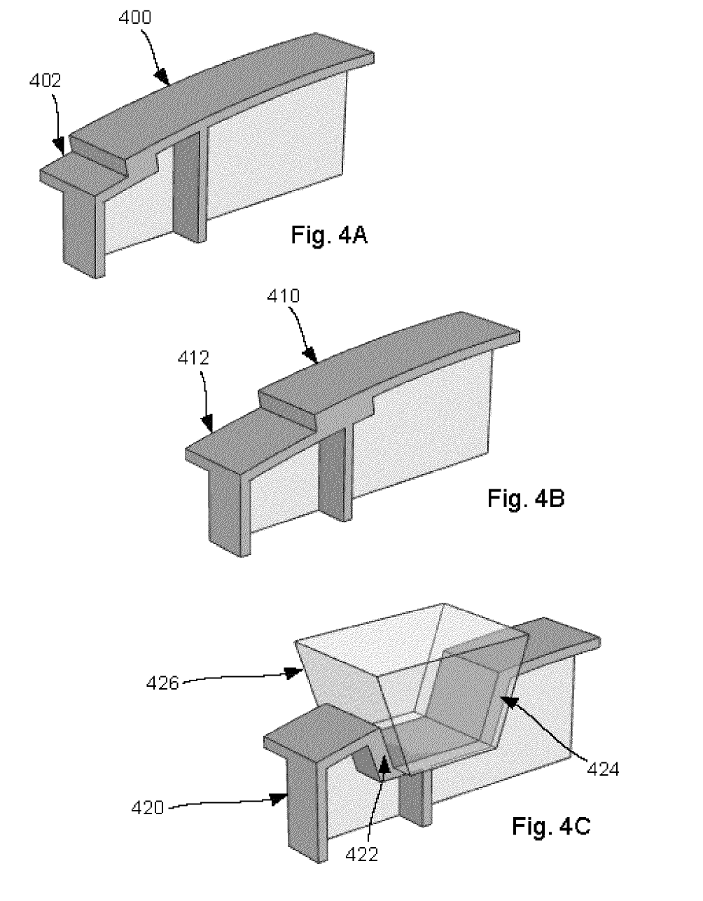

FIGS. 4A-4C illustrate models with various step features to accommodate respective second parts. FIG. 4A illustrates a model 400 with a step feature 402 that requires only a relatively short step feature to accommodate a second part as described herein. FIG. 4B illustrates a model 410 with a step feature 412 that requires a relatively long step feature to accommodate a second part as described herein. FIG. 4B illustrates a model 410 with a step feature 412 that requires a relatively long step feature to accommodate a second part as described herein. FIG. 4C illustrates a model 420 with step features 422 and 424 that together accommodate a second part 426 as described herein.

In various embodiments, the parameters of the step feature such as length, depth, and slope of the step feature faces can be received as input from a user or can be determined automatically by the system, such as by analyzing the corresponding faces of the second part. Various embodiments accept a variety of inputs and options and produce multitudes of feature configurations to accommodate the varied inputs.

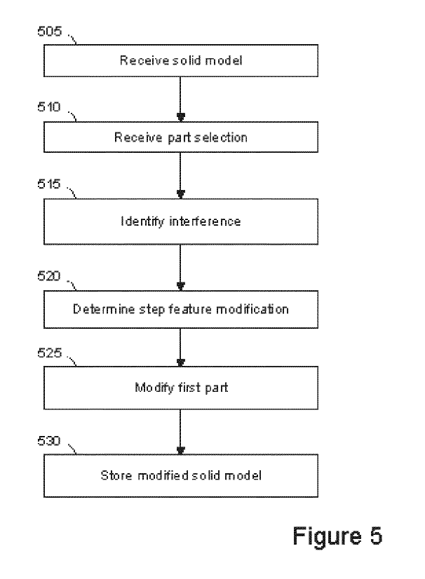

FIG. 5 illustrates a flowchart of a process in accordance with disclosed embodiments that may be performed, for example, by a CAD system as described herein.

The system receives a solid model including a plurality of parts (505). Receiving, as used herein, can include loading from storage, receiving from another device or process, receiving via an interaction with a user, or otherwise. In some cases, the parts are aerospace parts.

The system receives a selection of a first part and a second part of the solid model (510). This can include receiving a selection of a specific face on one or the other of the parts. The selection can be received from a user input or can be automatically determined by the system based on interferences or collisions between the parts. A selected specific face could be, for example, a flange face.

The system identifies an interference between the first part and the second part (515). The interference can include areas of the solid model in which both the first part and the second part exist (an area of collision between the first part and the second part), and can include areas of the solid model in which the first part and second part do not actually collide with each other, but are within a predetermined distance of each other.

The system determines a step feature modification to the first part based on the identified interference (520). The step feature modification can also be based on a user parameter input, including such parameters as length, depth, and slope of the step feature faces. Determining the step feature modification can include identifying one or more features of the first part that must be moved or deformed to produce the step feature modification, whether variationally or non-variationally. The step feature modification can be a modification to the first part to move a portion of the first part so that it conforms to faces of the second part but does not interfere or collide with the second part. The step feature modification can include, for example, a new flange face on the first part that conforms to the second part, and corresponding modifications to end faces, ribs, flange walls, and webs of the first part. The step feature modification can include such modifications as divide and offset, a “T belt,” an across-rib face, an access slot, one or more reference faces, curves, projected edges, replacement faces, chamfers, and others.

The system modifies the first part to add the step feature modification to create a modified solid model (525).

The system stores the modified solid model (530).

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method performed by a data processing system, comprising:
receiving a solid model including a plurality of parts;
receiving a selection of a first part and a second part of the solid model;
identifying an interference between the first part and the second part;
determining a step feature modification to the first part based on the identified interference;
modifying the first part to add the step feature modification to create a modified solid model and
storing the modified solid model.

2. The method of claim 1, wherein the data processing system receives a selection of a specific face on the first part.

3. The method of claim 1, wherein the identified interference is an area of collision between the first part and the second part.

4. The method of claim 1, wherein the step feature modification is also based on a user parameter input.

5. The method of claim 4, wherein the user parameter input is at least one of length, depth, and slope.

6. The method of claim 1, wherein the step feature modification is a modification to the first part so that the first part conforms to faces of the second part but does not collide with the second part.

7. The method of claim 1, wherein the first and second parts are aerospace parts.

8. A data processing system comprising:
a processor; and
an accessible memory, the data processing system particularly configured to receive a solid model including a plurality of parts;
receive a selection of a first part and a second part of the solid model;
identify an interference between the first part and the second part;
determine a step feature modification to the first part based on the identified interference;
modify the first part to add the step feature modification to create a modified solid model; and
store the modified solid model.

9. The data processing system of claim 8, wherein the data processing system receives a selection of a specific face on the first part.

10. The data processing system of claim 8, wherein the identified interference is an area of collision between the first part and the second part.

11. The data processing system of claim 8, wherein the step feature modification is also based on a user parameter input.

12. The data processing system of claim 11, wherein the user parameter input is at least one of length, depth, and slope.

13. The data processing system of claim 8, wherein the step feature modification is a modification to the first part so that the first part conforms to faces of the second part but does not collide with the second part.

14. The data processing system of claim 8, wherein the first and second parts are aerospace parts.

15. A non-transitory computer-readable medium encoded with executable instructions that, when executed, cause one or more data processing systems to:
receive a solid model including a plurality of parts;
receive a selection of a first part and a second part of the solid model;
identify an interference between the first part and the second part;
determine a step feature modification to the first part based on the identified interference;
modify the first part to add the step feature modification to create a modified solid model; and
store the modified solid model.

16. The computer-readable medium of claim 15, wherein the data processing system receives a selection of a specific face on the first part.

17. The computer-readable medium of claim 15, wherein the identified interference is an area of collision between the first part and the second part.

18. The computer-readable medium of claim 15, wherein the step feature modification is also based on a user parameter input.

19. The computer-readable medium of claim 18, wherein the user parameter input is at least one of length, depth, and slope.

20. The computer-readable medium of claim 15, wherein the step feature modification is a modification to the first part so that the first part conforms to faces of the second part but does not collide with the second part.
